(19) United States
(12) Patent Application Publication
(10) Pub. No.: US 2014/0209038 A1
(43) Pub. Date: Jul. 31, 2014

(54) Pet Chew Toy

(71) Applicant: David F. Simon, Lakeland, FL (US)

(72) Inventor: David F. Simon, Lakeland, FL (US)

(21) Appl. No.: 14/149,865

(22) Filed: Jan. 8, 2014

Related U.S. Application Data
(60) Provisional application No. 61/757,769, filed on Jan. 29, 2013.

(51) Int. Cl. A01K 11/00

(52) U.S. Cl. CPC A01K 15/026
USPC 119/709

(57) ABSTRACT

A pet chew toy has a body which is formed from an elastic plastic/elastomer and has an opening extending into an associated internal cavity in the body into which treats larger than the opening can be inserted due to the elasticity of the material and returned therein due to the relaxed size of the opening. Chewing by the pet fragments the treats and allows the smaller fragments to fall out through the opening. The opening can be slots, rounded holes, or other openings to vary the technique needed to extract the treats from the toy.

### CROSS REFERENCE TO RELATED APPLICATIONS

This application claims the benefit of U.S. provisional application No. 61/757,769 filed on Jan. 29, 2013.

### BACKGROUND OF THE INVENTION

This invention concerns pet toys and more particularly so called “chew” toys, particularly for dogs.

Chew toys are designed to entertain pets and also to help keep their teeth and gums healthy. It has therefore been known to provide slots in a rigid body into which treats can be inserted to encourage pets to chew the toy in order to extract the treats.

Typical chew toys are described in U.S. Pat. Nos. 7,506,614; 6,546,896 and 7,032,541.

Such an arrangement offers only minimal interest to the pet in efforts to extract the treats.

Only minimal space for treats is provided by the surface grooves, and secure retention of the treats is often not achieved.

The extraction of the treats may be relatively difficult as only small fragments can be extracted from the grooves but also simply fall out

Also, the stiffness of construction of these solid toys may be a discouragement to pets which are smaller and have less jaw strength.

Those chew toys do not involve a substantial penetration of a pet's teeth into the toy such that cleaning of the pet's teeth is minimal.

It is an object of the present invention to provide a pet chew toy which requires a significant effort by the pet to extract the treats, providing a sustained interest.

It is another object to provide a chew toy which may be loaded with more treats than conventional chew toys.

It is another object to provide a chew toy which is more effective in cleaning the pet's teeth.

### SUMMARY OF THE INVENTION

The above recited objects of the invention and other objects which will be understood by those skilled in the art are achieved by a chew toy which includes a hollow body constructed of a tough but flexible plastic which is readily flexed upon being chewed on by a pet.

The hollow body has one or more internal cavities of various configurations such as elongated straight or curved chambers or short cavities of a rounded shape.

Slots or holes extend through an outer wall of the toy into each of the cavities creating walls inclined so as to partially overlie the associated internal cavity. The slots or holes provide an opening of a smaller size than the treats and internal cavities into which they extend.

The walls are readily stretchable to allow insertion of treats larger than the opening and also allow the walls to be pulled apart to create a larger opening to thereby enable placement of treats substantially larger than the slot into the associated cavity.

The readily flexed plastic walls are easily forced inwardly by the pet biting on the chew toy which causes the walls to engage and crush the treat into smaller pieces able to drop out through the slot or round opening to allow it to be retrieved by the pet.

The relatively large inward displacement of the walls during chewing enhances the tooth cleaning effect of the chewing action.

The various configurations of the openings and cavities require different extraction techniques by the pet to hold the pet's interest for extended periods.

### DESCRIPTION OF THE DRAWINGS

FIG. 1 is a pictorial view of a wishbone shaped pet chew toy according to a first embodiment of the invention.

FIG. 2 is a view of the section A-A taken in FIG. 1.

FIG. 3 is a left end view of the pet chew toy embodiment shown in FIG. 1.

FIG. 4 is a top view of the pet chew toy embodiment shown in FIG. 1.

FIG. 5 is a right end view of the pet chew toy embodiment in the direction A-A in FIG. 4.

FIG. 6 is a right side view in the direction B-B in FIG. 5, the left side being a mirror image.

FIG. 7 is a pictorial view of a dog bone shaped second pet chew toy embodiment according to the invention.

FIG. 8 is a plan view of the pet chew toy embodiment shown in FIG. 7.

FIG. 9 is a right end view of the pet chew toy embodiment shown in FIG. 7, the right end being a mirror image.

FIG. 10 is a front view of the pet chew toy embodiment shown in FIG. 8, the rear view being a mirror image.

FIG. 11 is a view of the section A-A taken in FIG. 8.

FIG. 12 is a pictorial view of a star shaped third embodiment of a pet chew toy according to the invention.

FIG. 13 is a front view of the third pet chew toy embodiment shown in FIG. 12, the rear view being identical.

FIG. 14 is a bottom view of the pet chew toy shown in FIG. 12, the top view being a minor image thereof.

FIG. 15 is a view of the section A-A shown in FIG. 14.

FIG. 16 is a pictorial view of a fanciful fish shaped pet chew toy according to a fourth embodiment of the invention.

FIG. 17 is a plan view of the pet chew toy shown in FIG. 16.

FIG. 18 is a front end view of the pet chew toy shown in FIG. 16.

FIG. 19 is a front view of the pet chew toy shown in FIG. 16, the rear view being a minor image.

FIG. 20 is a pictorial view of a ring shaped fifth embodiment of the pet chew toy according to the invention.

FIG. 21 is a plan view of the pet chew toy shown in FIG. 20.

FIG. 22 is a view of the section A-A in FIG. 21.

FIG. 23 is a pictorial view of a sixth embodiment of a pet chew toy according to the invention.

FIG. 24 is a side view of the pet chew toy shown in FIG. 23.

FIGS. 25 and 26 are views of the sections A-A and B-B respectively taken in FIG. 24.

FIG. 27 is a plan view of the pet chew toy shown in FIG. 23.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

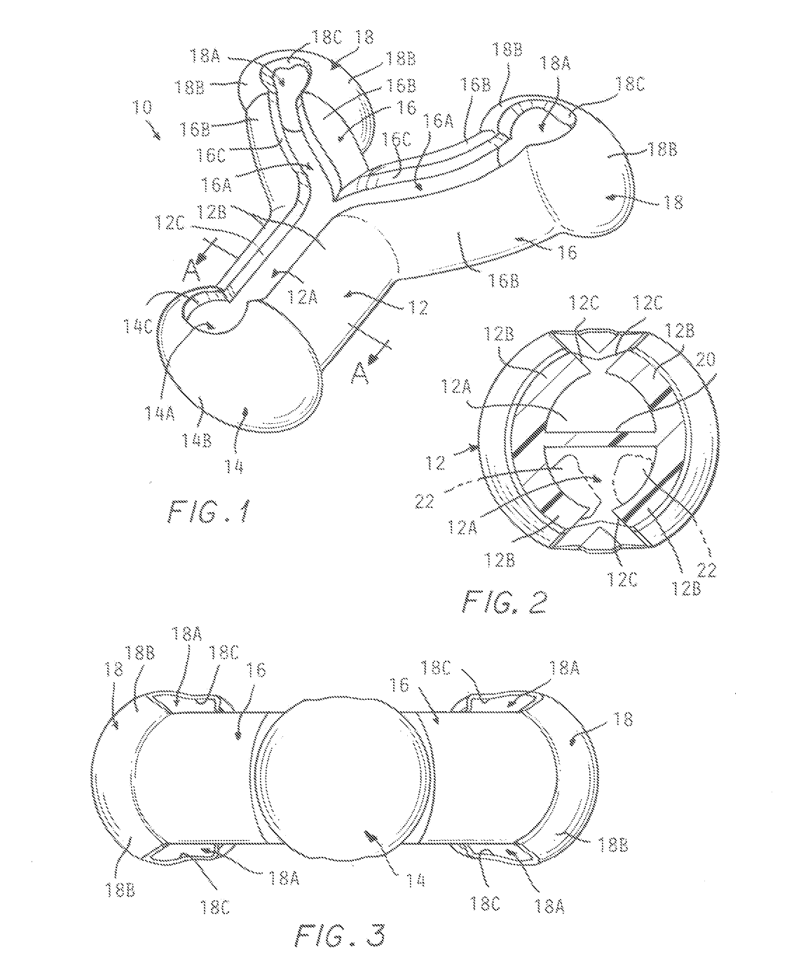

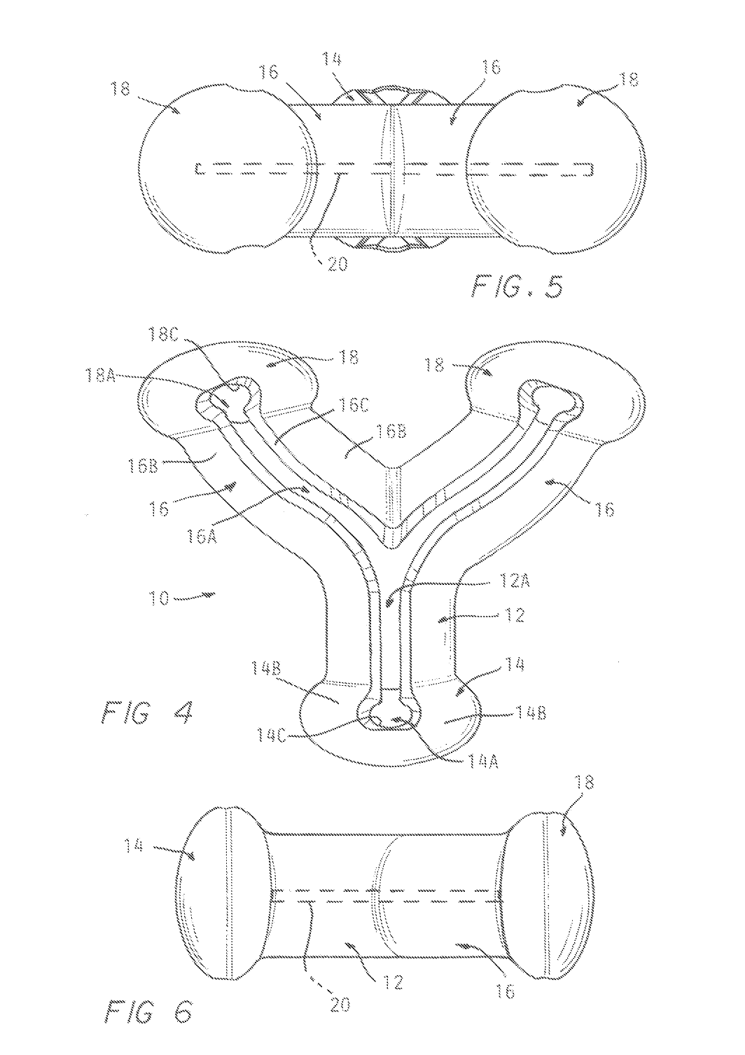

Referring to FIGS. 1-6, a first embodiment of a pet chew toy 10 according to the invention is shown therein. This embodiment comprises a body of a general “wishbone” shape, having an elongated hollow straight stem portion 12 terminating in a hollow enlarged knob end 14, and a pair of hollow curved elongated branch portions 16 both integral with one end of the stem portion 12, the branches 16 also both terminating in hollow enlarged knob ends 18.

The pet chew toy 10 is preferably molded from a tough abrasion resistant plastic such as a TPU (thermoplastic polyurethane) or a TPE (thermoplastic elastomers) to withstand abrasion and sustained chewing by dogs or other pets.

The plastic used must be formulated so that the outer portions of the chew 10 are readily flexed inwardly by the pet in biting down on the chew toy 10.

Each of the straight stem portion 12, the enlarged ends 14, branches 16 and enlarged ends 14 and 18 thereof are hollow, having pairs of internal cavities, each on one side of a common internal partition (FIG. 2). The pairs of internal cavities 12A, 14A, 16A and 18A are defined by opposing pairs of curved walls 12B, 14B, 16B and 18B extending towards each other and over the respective cavities 12A, 14A, 16A and 18A.

A pair of central slots 12C and 16C extend between each of the outer pairs of walls 12B and 16B opening into a respective cavity 12B, 16B.

The enlarged ends 14, 18 have rounded pairs of openings 14C and 18C extending into the respective cavities 14A, 18A.

The slots 12C and 16C and holes 14C and 18C are smaller than the cavities 12A, 14A, 16A and 18A with which they are associated such as to enable treats inserted therein to be retained. The pairs of walls 12B, 14B, 16B and 18B can be readily pulled apart to allow insertion of a treat 22 larger than the slots or holes or the larger treats may also be inserted by being pushed in through the same, stretching of the plastic allowing passage of the treat.

The pet chewing on the toy 10 will cause the walls 12B, 14B, 16B and 18B to be compressed inwardly to crush the treats 22 into smaller pieces which can then drop out through the various slots and holes to be able to be eaten by the pet.

The relatively gross deformations of the walls 12B, 14B, 16B and 18B caused by chewing enhance the cleaning action on the pet's teeth and also stimulation of the pet's gums.

The differing shapes of the slots and holes require different techniques to extract the treats, lengthen the time of interest in the toy.

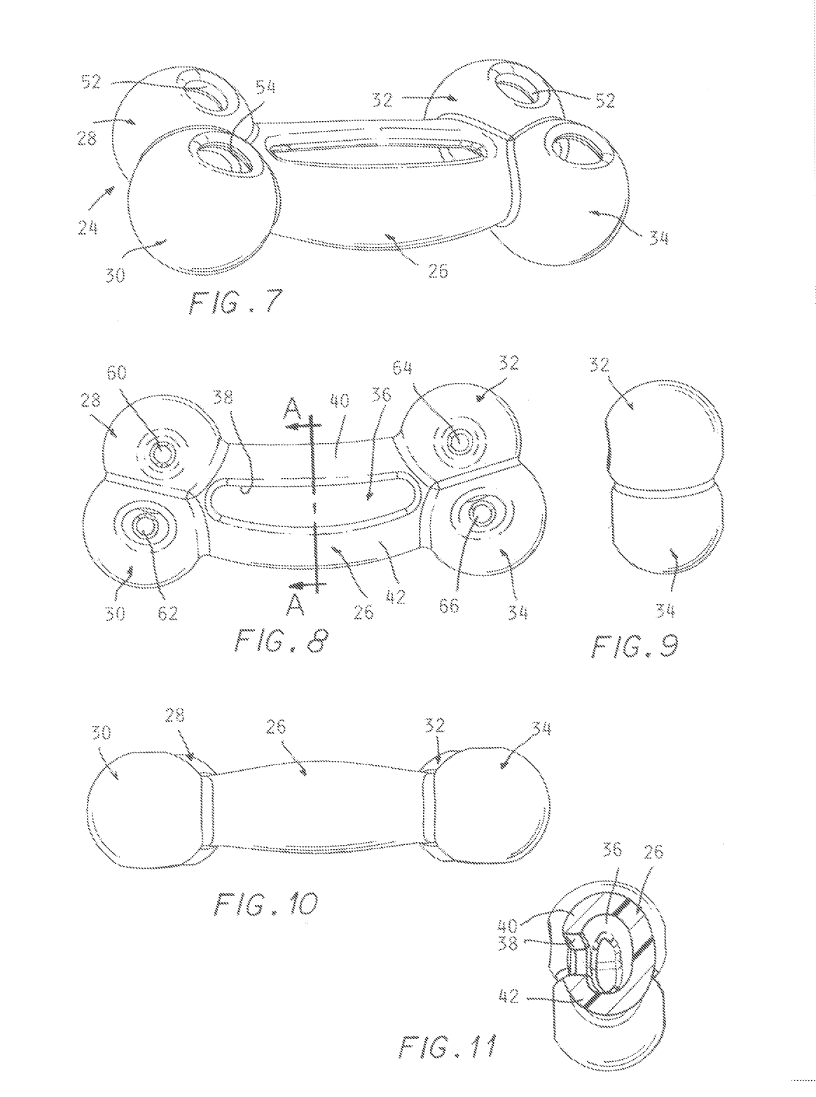

FIGS. 7-11 show a “dog bone” shape form of the body of a chew toy 24 according to a second embodiment of the invention, with a hollow curved elongated portion 26 at the middle, and hollow rounded end portions 28, 30, 32, 34, attached at each end of the elongated portion 26.

A single cavity 36 extends within the elongated portion 26 with a single slot 38 defined between two curved walls 40, 42 extending towards each other and opening into the cavity 32.

Each hollow rounded end portion 28, 30, 32, 34 has a rounded cavity 44, 46, 48, 50 defined therein with a large circular opening 52, 54, 56, 58 opening into each respective cavity from the top of the chew toy 24.

A small venting opening 60, 62, 64, 66 is at the back of each end portion 28, 30, 32, 34 to prevent a vacuum from being crated.

Curving walls extend around each large opening 52, 54, 56, and 58.

The flexibility of each of the walls 40, 42 and around each large opening allows pushing insertion of a larger sized treat by stretching of the plastic material. A compression of the walls 40, 42 crushes the treats to allow the fragments to drop out in a similar fashion to the first described embodiment.

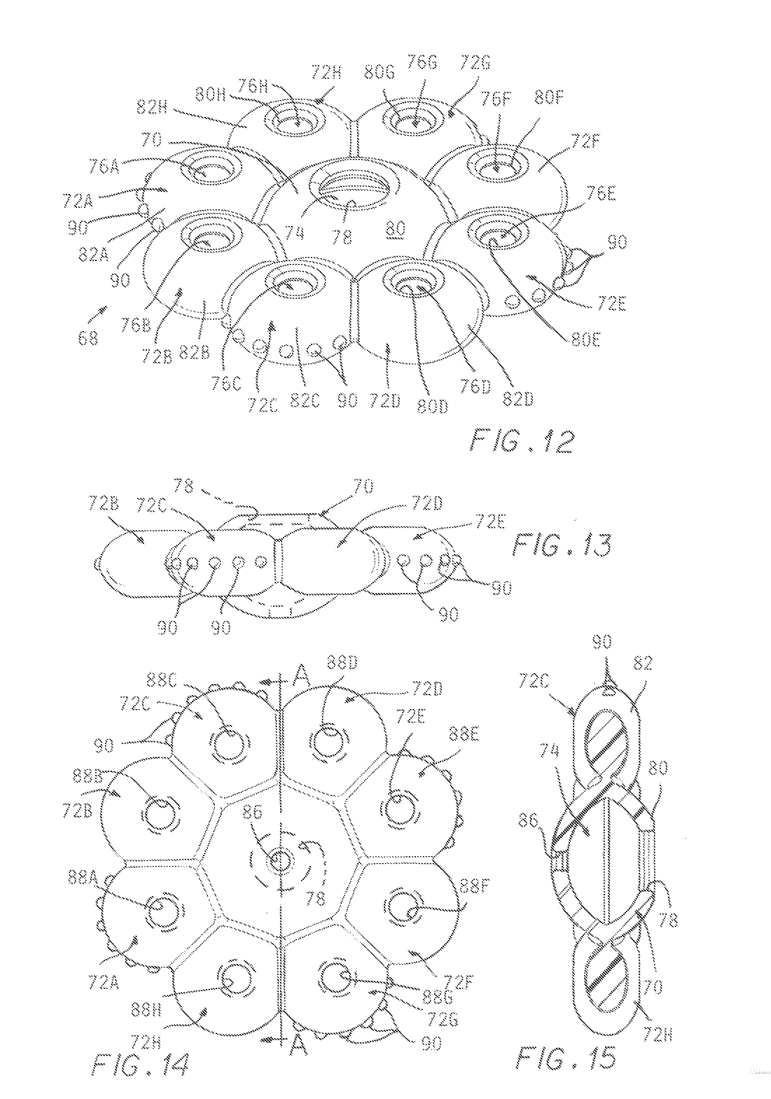

FIGS. 12-15 show a body of a star pattern chew toy 68, in which a hollow flattened spherical central portion 70 is surrounded by a ring of smaller hollow flattened spherical portions 72A-72H.

The spherical portions 70, 72A-72H are approximately shaped as spheres which are flattened somewhat as can be seen in FIGS. 13 and 15. Each has an interior cavity 74, 76A-76H large circular opening 78, 80A-80H in the top allows access to the associated cavity 74, 76A-76H.

The exterior top wall 32 of each rounded portion 70, 72A-72H arches over the associated interior cavity 74, 76A-76H at the top thereof.

Treats larger than the openings 78, 80A-80H can be inserted into these openings 74, 76A-76H therein due to the flexibility and stretchability of the wall 80??, 82A-82H.

Smaller vent openings 86, 88A-88H are also included to prevent development of a vacuum.

Rounded protrusions 90 extending from the outer diameter are provided in alternate portions 72A, 72C, 72E, 72G to create features for tooth cleaning.

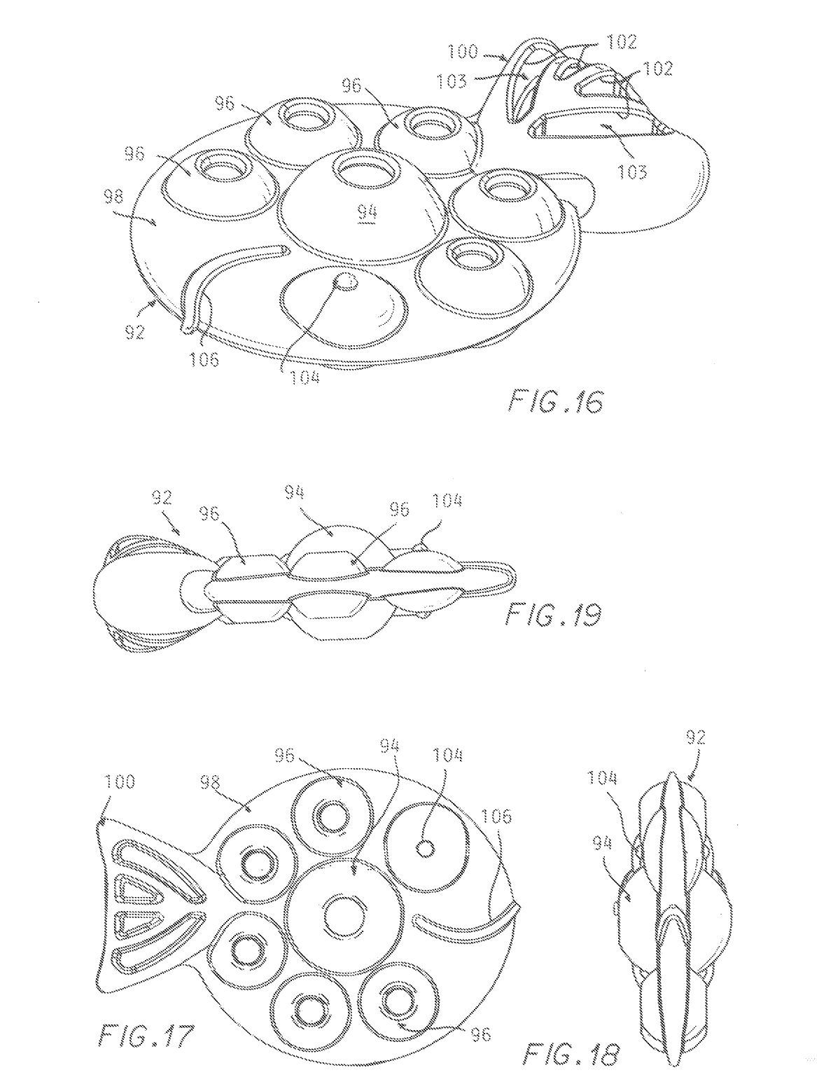

A fanciful fish shaped embodiment of a chew toy 92 is shown in FIGS. 16-19 which has hollow flattened spherical portions 94 and 96 similar to those of chew toy 68 but molded into a circular solid portion 98.

A hollow tail portion 100 has slotted openings 102 extending into a cavity 102. A solid “eye” 104 and small mouth ridge 106 add to the fanciful fish shape.

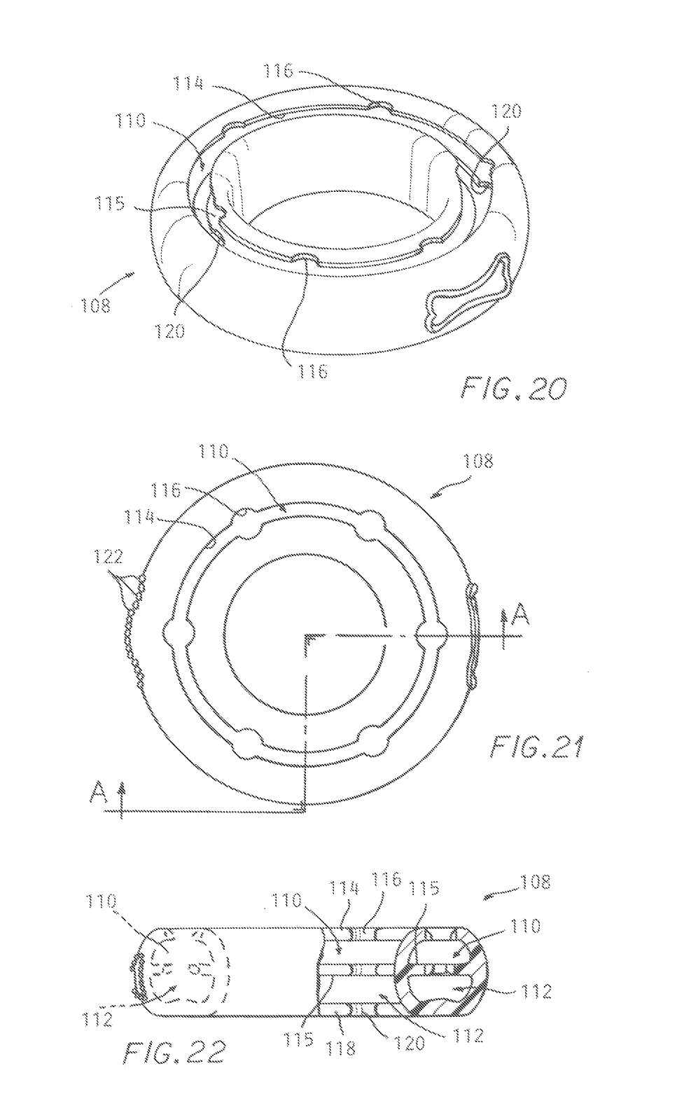

FIGS. 20-22 show a ring shaped chew toy 108 having an upper ring cavity 110 and lower ring cavity 112 separated by an intermediate web 115. Annular slots 114, 118 with spaced partially circular enlarge vents 116, 120 allow treats to be inserted into the annular cavities 110 and 112 by stretching of the flexible walls of the ring shaped surface, and protrusions 122 can be provided.

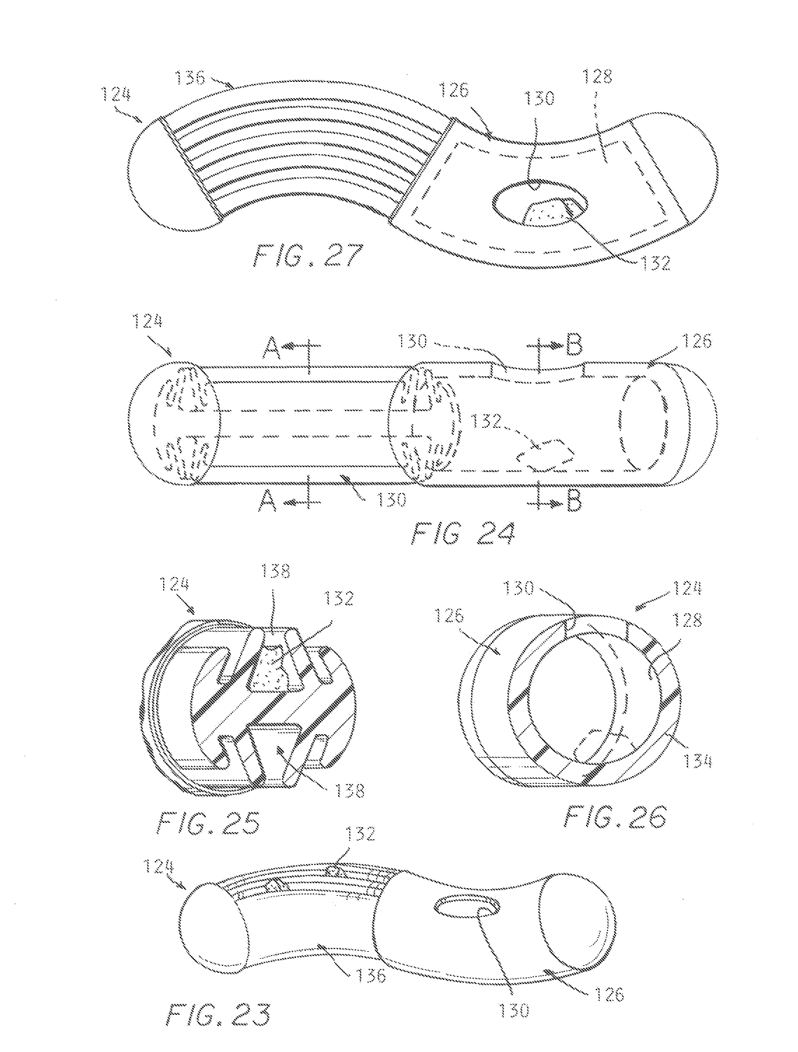

FIGS. 23-27 depict a curved stick form of a chew toy 124. This embodiment combines a hollow end 126 which has an internal cavity 128 with an oval opening 130 into which treats 132 can be inserted to be held in the cavity.

The flexible wall 134 can be easily crushed by the pet chewing on the toy to enable fragments to drop out through the opening 130 as in the other embodiments.

The chew toy 124 has a slotted portion 136 at the other end which is formed with a central slot 138 on each side.

A pair of flexible plastic walls 140 is angled towards each other to create an enlarged bottom of the slot 138 to retain inserted treats 132 therein.

Again, the dog in biting on the toy 124 can collapse the walls down to crush the treats 138 and allow the fragments to easily pass out of the narrow part of the slot.

1. A chew toy comprising:
a flexible plastic hollow body having at least one internal cavity;
said cavity defined at least in part by an outer wall of said body extending partially over said internal cavity;
at least one opening extending into said at least one cavity enabling treats to be inserted into said cavity through said opening;
said flexible plastic material allowing insertion of treats of a size necessitating deflection and/or stretching around said opening so that said treats of said size cannot pass back out from said cavity through said opening after insertion;
said chew toy having outer portions which are readily collapsed by chewing pressure applied by chewing of said chew toy body by said pet sufficient to break down said treats into smaller fragments able to freely pass out through said at least one opening.

2. The pet chew according to claim 1 wherein said body includes an elongated portion with said cavity being elongated within said elongated portion opening and a slot extending along said elongated portion and entering into said elongated cavity.

3. The chew toy according to claim 1 wherein said internal cavity is rounded and said opening comprises a hole extending into said rounded cavity.

4. The chew toy according to claim 2 further including an additional rounded cavity adjacent said elongated cavity and a rounded hole in said body extending into said rounded cavity.

5. The chew toy according to claim 1 wherein said body has a wishbone shape with an end portion and two additional branch elongated stem portions each having one end extending from one end of said stem portion with elongated cavities in each of said elongated stem and branch portions and slots extending along each of said portions and into a respective internal cavities.

6. The chew toy according to claim 5 further including enlarged end portions at a free end of each of said elongated stem and branch portions with a rounded cavity in each end portion and a rounded hole extending into each rounded cavity.

7. The chew toy according to claim 2 further including an enlarged rounded end at each end of said elongated portion each enlarged end having an internal cavity and a rounded opening extending into each internal cavity.

8. The chew toy according to claim 7 further including a additional elongated portion side by side with said elongated portion with an enlarged end portion at either end of said additional elongated portion each having a rounded internal cavity and a rounded hole extending into each rounded internal cavity therein.

9. The chew toy according to claim 1 wherein a partition portion extends across said internal cavity and a second internal cavity is located on the other side of said partition with an associated opening extending thereinto.

10. The chew toy according to claim 1 wherein a plurality of rounded internal cavities are arranged in a circle with a rounded opening extending into each internal cavity.
